(19) United States
(12) Patent Application Publication
(10) Pub. No.: US 2009/0017301 A1
(43) Pub. Date: Jan. 15, 2009

(54) GLASS FIBRES AND GLASS FIBRE STRUCTURES PROVIDED WITH A COATING CONTAINING NANOPARTICLES

(75) Inventor: Patrick Moireau, Curienne (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Ssint-Gobain Technical Fabrics Europe, Chambery (FR)

(21) Appl. No.: 12/158,707

(22) PCT Filed: Dec. 22, 2006
(86) PCT No.: PCT/FR2006/051422

§ 371 Date: Sep. 29, 2008

(30) Foreign Application Priority Data
Dec. 23, 2005 (FR) 0554078

(51) Int. Cl. B32B 17/06; C08K 3/34; C08K 3/10; C08J 3/205

(52) U.S. Cl. 428/372; 524/445; 524/446; 524/444; 524/437; 523/333

(57) ABSTRACT

The invention relates to reinforcing glass strands and the structures of such glass strands having an improved wet aging resistance and equipped with a coating composition, obtained from a solution and/or a suspension and/or an emulsion, that comprises (in % by weight of solids):
60 to 95% of at least one polymer
2 to 18% of nanoparticles.

It also relates to a coating composition suitable for coating said strands and strand structures, its production method and the composites incorporating the strands and strand structures.

The present invention relates to glass strands and glass strand structures equipped with a coating containing nanoparticles, especially clay or boehmite, intended to reinforce organic and/or inorganic materials.

It also relates to the coating composition that can be applied onto said strands and said structures, the method of preparing said composition and the composites incorporating such strands and structures.

Conventionally, reinforcing glass strands are produced by mechanically attenuating molten glass streams flowing out from numerous orifices in a bushing filled with molten glass, under gravity, under the effect of the hydrostatic pressure due to the height of the liquid, in order to form filaments that are coated with a size and assembled into base strands, these strands then being collected on a suitable support.

The glass strands in their various forms (continuous, chopped or ground strands, mats, meshes, wovens, knits, etc.) are commonly used for the effective reinforcement of matrices of various types, for example thermoplastic or thermosetting organic materials and inorganic materials, for example cement.

Although the size helps to a large extent to protect the filaments from chemical and environmental attacks, the level of strand protection is most often insufficient and must be improved. In particular, it is desired to increase the aging resistance of the glass strands that are incorporated into corrosive matrices, for example cementitious materials, or that are in contact with aqueous media or media containing organic solvents.

The object of the present invention is to improve the aging resistance in a wet environment of glass strands and of glass strand structures intended in particular to be incorporated as reinforcing components for organic and/or inorganic materials.

This object is achieved according to the invention by the glass strands and the glass strand structures equipped with a coating based on a polymer that contains nanoparticles.

More precisely, one subject of the invention is reinforcing glass strands and reinforcing glass strand structures equipped with a coating composition, obtained from a solution and/or a suspension and/or an emulsion that comprises (in % by weight of solids):
60 to 95% of at least one polymer;
2 to 18% of nanoparticles.

In the present invention, the term “nanoparticles” is understood to mean particles of a material that are formed from a cluster of atoms or molecules, which have one or more dimensions that may possibly vary between 1 and 100 nanometers, preferably between 1 and 50 nanometers. The shape of these particles may vary to a very large extent, for example, they may have the appearance of a sphere, a tube, a whisker, a flake or a platelet.

Still within the context of the invention, the term “strands” should be understood to mean the base strands resulting from the assembly of a multitude of filaments, and the products derived from these strands, especially assemblies of these base strands in the form of rovings. Such assemblies may be obtained by simultaneously unwinding base strands from several packages and then assembling said strands into tows that are wound onto a rotating support. They may also be “direct” rovings with a titer (or linear density) equivalent to that of assembled rovings, obtained by gathering the filaments directly beneath the bushing and winding onto a rotating support.

Also according to the invention, the term “coating composition” is understood to mean a composition capable of being deposited onto the strands and the strand structures and which is in the form of a solution and/or a suspension and/or a dispersion comprising at least 10% by weight of solvent, preferably at least 25% and at most 85%.

Finally, the term “solvent” is understood to mean water, organic solvents which may help dissolve certain constituents of the coating composition and mixtures of water with one or more of these solvents. By way of examples of such solvents, mention may be made of alkanes, alcohols, ketones and esters. In the majority of cases, the composition does not contain any organic solvent, especially in order to limit the emissions of volatile organic compounds (VOCs) into the atmosphere.

The polymer according to the invention confers protection against wet aging, gives the coating the necessary mechanical cohesion by making the nanoparticles adhere to the glass strand and by binding the nanoparticles together, and makes it possible to ensure binding with the material to be reinforced.

The choice of polymer depends on the targeted application. As a general rule, the polymer is an organic polymer, for example a polyvinyl alcohol, a polyvinyl acetate (homopolymer or copolymer, such as an ethylene/vinyl acetate copolymer), a polyvinyl chloride, a styrene-butadiene (SBR) or nitrile-butadiene (NBR) polymer or an acrylic polymer. Preferably, the polymer is polyvinyl alcohol, an SBR polymer or a polyacrylic.

Preferably, the polymer represents 75 to 90% of the weight of the coating composition.

The nanoparticles are essential to the coating because they make it possible to obtain a water and organic solvent barrier effect which is translated into a greater ability of the strand to be resistant to aging in a wet environment. This is because the nanoparticles are obstacles that prevent the rapid penetration of these compounds by creating, in the coating, torturous diffusion paths towards the glass, which is thus better protected. The degree of protection varies as a function of the quantity and the shape of the nanoparticles in the coating.

Particles of various dimensions may give the aforementioned effects. In this regard, the nanoparticles having a high aspect ratio (ratio of the largest dimension to the smallest dimension) such as platelets are particularly suitable as they are capable of being oriented parallel to the surface of the filaments, which gives the strand a greater aging resistance in a wet environment.

The nanoparticles conforming to the invention are composed of a mineral material, namely they contain more than 30% by weight of such a material, preferably more than 40%, and advantageously more than 45%.

Preferably, the nanoparticles are based on clay or boehmite.

The term “clay” is here to be considered in its general definition accepted by a person skilled in the art, namely it defines hydrated aluminosilicates of general formula Al₂O₃.SiO₂.xH₂O, where x is the degree of hydration. Such a clay consists of aluminosilicate sheets having a thickness of a few nanometers linked together by hydrogen bonds or ionic bonds between the hydroxide groups present in the sheets and water and/or the cations present between said sheets.

By way of example, mention may be made of mica type phyllosilicates, such as smectites, montmorillonite, hectorite, bentonites, nontronite, beidellite, volonskoite, saponite, sauconite, magadiite, vermiculite, mica, kenyaite and synthetic hectorites.

Preferably, the clay is chosen from 2:1 type phyllosilicates, advantageously smectites. The particularly preferred clay is montmorillonite.

The clay may be a calcined clay, for example one having undergone a heat treatment at a temperature of at least 750° C.

The clay may also be a modified clay, for example one modified by cationic exchange in the presence of a solution of an ammonium, phosphonium, pyridinium or imidazolium salt, preferably an ammonium salt.

The clay nanoparticles are generally in the form of platelets having a thickness of a few nanometers and a length which may possibly reach 1 micrometer, generally less than 100 nanometers, these platelets possibly being individual or aggregates.

The clay nanoparticles may be obtained by subjecting a clay, optionally calcined and/or modified as mentioned above, to the action of at least one expansion agent, which has the function of separating the clay sheets. For example, the expansion agent may be tetrahydrofuran or an alcohol such as ethanol, isopropanol, ethylene glycol, 1,3-propanediol, 1,4-butanediol and polyethylene glycols, especially with a molecular weight of less than 1200.

The term “boehmite” relates to alumina monohydrates. Preferably, the boehmite is a synthetic boehmite obtained by hydrothermal reaction from aluminum hydroxide.

The boehmite nanoparticles may be in the form of beads, whiskers, ellipsoids or platelets, the latter form being preferred.

Advantageously, the nanoparticles are treated by an agent that helps to slow down the diffusion of water and thus makes it possible to increase the aging resistance of the strand in a wet environment, preferably a hydrophobic agent.

Methods for making the particles hydrophobic are known.

For example, the nanoparticles may be made to react with a compound of formula RₐXY₄₋ₐ in the presence of water and an acid, in which formula:
R represents a hydrogen atom or a hydrocarbon-based radical incorporating 1 to 40 carbon atoms, said radical possibly being linear, branched or cyclic, saturated or unsaturated, possibly containing one or more O or N hetero atoms or being substituted by one or more amino, carboxylic acid, epoxy or amido groups, and the R groups being identical or different;
X represents Si, Zr or Ti;
Y is a hydrolysable group such as an alkoxy containing 1 to 12 carbon atoms, optionally containing one or more O or N hetero atoms, or a halogen, preferably Cl; and
a is equal to 1, 2 or 3.

Preferably, the compound corresponding to the aforementioned formula is an organosilane, advantageously an organosilane incorporating two or three alkoxy groups.

By way of example, mention may be made of γ-aminopropyltrimethoxysilane, γ-aminopropyltriethoxysilane, N-phenyl-γ-aminopropyltrimethoxysilane, N-styrylaminoethyl-γ-aminopropyltrimethoxy-silane, γ-glycidoxypropyltrimethoxysilane, γ-methacryloxypropyltrimethoxysilane, γ-acryloxypropyltrimethoxysilane, vinyltrimethoxysilane, vinyltriethoxysilane, tert-butylcarbamoylpropyltrimethoxysilane and γ-(polyalkylene oxide)propyltri-methoxysilanes.

Preferably, γ-aminopropyltriethoxysilane, N-phenyl-γ-aminopropyltri-methoxysilane, N-styrylaminoethyl-γ-aminopropyltrimethoxysilane, γ-glycidoxy-propyltrimethoxysilane and γ-methacryloxypropyltrimethoxysilane are chosen.

The grafting agent is added in an amount representing 15 to 75% by weight of the initial nanoparticles, preferably 30 to 70%.

Preferably, the nanoparticles represent 2.5 to 15% of the weight of the coating composition.

In addition to the aforementioned constituents that essentially participate in the coating structure, one or more other constituents may be present.

Thus, a plasticizer may be introduced that lowers the glass transition temperature of the polymer, which gives flexibility to the coating and limits the shrinkage after drying. The amount of plasticizer represents preferably from 5 to 25% by weight of the coating composition.

The coating may comprise a dispersant that helps in dispersing the nanoparticles and promotes the compatibility between the other constituents and water.

The dispersant may be chosen from:

organic compounds, especially
optionally halogenated, aliphatic or aromatic, polyalkoxylated compounds, such as ethoxylated/propoxylated alkyl phenols, preferably incorporating 1 to 30 ethylene oxide groups and 0 to 15 propylene oxide groups, ethoxylated/propoxylated bisphenols, preferably incorporating 1 to 40 ethylene oxide groups and 0 to 20 propylene oxide groups, ethoxylated/propoxylated fatty alcohols, preferably the alkyl chain of which comprises 8 to 20 carbon atoms and incorporating 2 to 50 ethylene oxide groups and up to 20 propylene oxide groups. These polyalkoxylated compounds may be block copolymers or random copolymers;
polyalkoxylated fatty acid esters, for example polyethylene glycol esters, preferably the alkyl chain of which comprises 8 to 20 carbon atoms and incorporating 2 to 50 ethylene oxide groups and up to 20 propylene oxide groups; and
amine compounds, for example optionally alkoxylated amines, amine oxides, alkylamides, optionally alkylated and/or alkoxylated amidoamines, sodium, potassium or ammonium succinates and taurates, sugar derivates especially from sorbitan, and sodium, potassium or ammonium alkyl sulfates, alkyl phosphates and ether phosphates; and

inorganic compounds, for example silica derivatives, these compounds possibly being used alone or in a mixture with the aforementioned organic compounds.

In order to avoid stability problems with the coating composition and an inhomogeneous dispersion of the nanoparticles, it is preferred to use cationic or nonionic surfactants.

Preferably, the amount of dispersant represents from 0.01 to 60% of the weight of nanoparticles, preferably from 0.25 to 50%.

A viscosity control agent may also be introduced, which makes it possible to adjust the viscosity of the composition to the conditions of application onto the strands, which viscosity is in general between 50 and 2000 mPa·s, preferably at least equal to 150 mPa·s. This agent also makes it possible to adapt the viscosity of the nanoparticle dispersions so as to allow them to be treated under high shear conditions in order to improve their state of dispersion and/or exfoliation, as is explained later in the text.

The viscosity control agent is chosen from polyvinyl alcohols, polyvinylpyrrolidones, hydroxymethyl celluloses, carboxymethyl celluloses and polyethylene glycols.

The amount of viscosity control agent in the coating is preferably between 0.5 and 25%, and advantageously between 1.5 and 18%.

The coating may also comprise:
0.2 to 20% by weight, preferably 0.1 to 10%, of a lubricant, for example a mineral oil, a fatty acid ester such as isopropyl palmitate or butyl stearate, an alkylamine or a polyethylene wax;
0.25 to 20% by weight, preferably 0.5 to 15%, of a complexing agent such as a derivative of EDTA, gallic acid or phosphonic acid; and
0.05 to 3% by weight, preferably 0.1 to 2%, of an antifoaming agent such as a silicone, a polyol or a vegetable oil.

All of the abovementioned compounds contribute to the production of glass strands and glass strand structures that can be easily manufactured, can be used as they are or as reinforcements, are incorporated without any problems into a resin during manufacture of the composites and in addition have a high aging resistance in a wet environment.

As a general rule, the amount of coating represents from 8 to 200% of the weight of the final strand or of the final strand structure, preferably 15 to 100%, and most often 20 to 60%.

The strand equipped with the coating conforming to the invention may be made from glass of any kind, for example E-glass, C-glass, R-glass and AR-glass, and glass with a low boron content (less than 6%). E-glass and AR-glass are preferred.

The diameter of the glass filaments constituting the strands may vary to a large extent, for example from 5 to 30 μm. Likewise, wide variations may occur in the linear density of the strand, which may range from 11 to 4800 tex depending on the intended applications.

Another subject of the invention is the coating composition that can be deposited on the glass strands and the glass strand structures. It comprises the aforementioned constituents and a solvent.

The coating composition comprises (in % by weight):

8 to 90% of at least one polymer, preferably 10 to 75%;

1 to 15% of nanoparticles, preferably 1.5 to 10%;

0 to 10% of at least one lubricant, preferably 0.1 to 6%;

0 to 15% of at least one dispersant, preferably 0.1 to 8%; and

0 to 15% of at least one viscosity control agent, preferably 0.1 to 8%.

The amount of solvent to be used is determined so as to obtain a solids content that varies from 8 to 90%, preferably from 15 to 75%.

The preparation of the coating composition is carried out in the following manner:
a) the nanoparticles are dispersed in the solvent, preferably in the presence of a dispersant and if necessary a viscosity control agent; and
b) the polymer and the aforementioned optional constituents are added to the nanoparticle dispersion.

Advantageously, step a) is carried out with sufficient stirring to avoid the risk of nanoparticle sedimentation.

The dispersion of nanoparticles based on a sheet-like material, such as clay or boehmite, may be obtained in various ways, all having the purpose of increasing the degree of dispersion and/or exfoliation of the material.

According to a first embodiment, the nanoparticles are introduced into the solvent containing a dispersant and the mixture is treated under high shear conditions, for example, in an Ultraturax® device and/or is subjected to the action of ultrasound.

By way of indication, a good dispersion of nanoparticles is obtained by treating the mixture in an Ultraturax® at a speed of 3000 to 10 000 rpm for 5 to 30 minutes or by ultrasound with a power of 200 W and a frequency of 20 kHz for 15 to 120 minutes.

Advantageously, a viscosity control agent is introduced into the mixture before the treatment, in particular when the nanoparticles are being sheared.

Where appropriate, one part of the polymer from step b) may be added to the dispersion before the shear treatment, which makes it possible to reduce the amount of dispersant and optionally to carry out a more suitable adjustment of the viscosity.

According to a second embodiment, the nanoparticles are mixed with the granules of a thermoplastic polymer such as a polyvinyl acetate, a polyamide and a polyurethane, or of a thermosetting polymer such as an epoxy, phenolic or acrylic resin, and a polyurethane, and the mixture is introduced into an extruder. The extrudates are then emulsified in the solvent under the conditions known to a person skilled in the art.

The application of the coating onto the reinforcing glass strand and the structure of such glass strands may be carried out by any known means.

This means may consist in spraying the coating composition over the strand, or in immersing the strand in a bath of the coating composition and making it pass, on leaving the bath, into a calibrating nozzle that enables the quantity to be deposited onto the strand to be regulated.

In the case of a strand structure, especially a mesh or a woven, the coating composition may be applied by spraying, by immersion in a bath of said composition generally followed by a calendering operation, or by passing the structure onto a device operating by kiss coating, for example using a calibrating blade that fixes the thickness of the coating.

The solvent is usually removed by drying the strand and the strand structure before their collection in package form, for example via a thermal route using hot air or via contact with one or more drying rolls, or via an infrared radiation treatment.

The strand or the strand structure equipped with the coating thus obtained may undergo an additional coating operation with a coating composition that is identical or different from the previous one, especially which may or may not comprise nanoparticles.

Another subject of the invention is a composite that comprises at least one organic and/or inorganic material and glass strands or one or more glass reinforcing strand structures, said strands or structure(s) being made entirely or partly of glass strands or glass strand structure(s) equipped with the coating composition according to the invention. The organic material may be made from one or more thermoplastic or thermosetting polymers, and the inorganic material may be for example a cementitious material, a plaster or a mortar, especially contained in facing coating assemblies.

The glass content within the composite material is generally between 0.5 and 75% by weight, preferably 5 to 50%.

The examples given below illustrate the invention without however limiting it.

In the examples, the following raw materials are used to prepare the coating compositions and sizing compositions:

polymer (coating):
polyvinyl alcohol (degree of hydrolysis: 98%), sold under the reference “CELVOL® 325” by Vinamul, with a solids content of 97.5%;
styrene/butadiene rubber (SBR), sold under the reference “STYRONAL® D517” by BASF, with a solids content of 50%;

crosslinking agent (coating):

polyamide epoxy, sold under the reference “POLYCUP® 172LX” by Hercules, with a solids content of 13.5%

film-forming agents (size)
bisphenol A epoxy resin, sold under the reference “EPIREZ® 3510 W 60” by Resolution, with a solids content of 60%;
bisphenol A epoxy resin/1-methoxy-2-propanol mixture, sold under the reference “NEOXIL® 962D” by DSM, with a solids content of 40%;
ETS4, mixture containing 30.7% by weight of bisphenol A epoxy resin (sold under the reference “ARALDITE CY 207” by Huntsman) and 10% by weight of polyester resin (sold under the reference “NORSODYNE So56” by Cray Valley); with a solids content of 64%;

nanoparticles:
clay A: montmorillonite modified by ion exchange with a quaternary ammonium, sold under the reference “Dellite® 67G” by Laviosa Chimica Mineraria, with a solids content of 100%;
clay B: montmorillonite modified by ion exchange with a quaternary ammonium (sold under the reference “Dellite® 67G” by Laviosa Chimica Mineraria) treated in dispersion in water with N-styrylaminoethyl-γ-aminopropyltrimethoxysilane (sold under the reference “SILQUEST A-1128” by GE Silicones), with a solids content of 100%;
clay C: montmorillonite modified by ion exchange with a quaternary ammonium (sold under the reference “Dellite® 67G” by Laviosa Chimica Mineraria) treated in dispersion in ethylene glycol with N-styrylaminoethyl-γ-aminopropyltrimethoxysilane (sold under the reference “SILQUEST A-1128” by GE Silicones), with a solids content of 100%;
clay D: montmorillonite modified by ion exchange with a quaternary ammonium (sold under the reference “Dellite® 67G” by Laviosa Chimica Mineraria) treated in dispersion in PEG 300 with N-styrylaminoethyl-γ-aminopropyltrimethoxysilane (sold under the reference “SILQUEST A-1128” by GE Silicones), with a solids content of 100%;
clay E: montmorillonite (sold under the reference “Dellite® HPS” by Laviosa Chimica Mineraria) treated in dispersion in PEG 300 with N-styrylaminoethyl-γ-aminopropyltrimethoxysilane (sold under the reference “SILQUEST A-1128” by GE Silicones), with a solids content of 100%
boehmite in platelet form, obtained by hydrothermal synthesis from hydroxyalumina;
   Boehmite A: particles of size less than 50 nm, with a solids content of 28%;
   >Boehmite B: modified by γ-aminopropyltriethoxysilane (sold under the reference “SILQUEST® A-1100” by GE Silicones) in formic acid, 1% of the weight of the nanoparticles, with a solids content of 25%;
   >Boehmite C: modified by γ-aminopropyltriethoxysilane (sold under the reference “SILQUEST® A-1100” by GE Silicones), 2% of the weight of the nanoparticles, with a solids content of 100%;
   >Boehmite D: modified by γ-methacryloxypropyltrimethoxysilane (sold under the reference “SILQUEST® A-174” by GE Silicones), 1% of the weight of the nanoparticles, with a solids content of 100%;

coupling agents (size):
γ-methacryloxypropyltriethoxysilane, sold under the reference “SILQUEST® A-174NT” by GE Silicones, with a solids content of 80%. The compound was first hydrolyzed in the presence of acetic acid;
silylated polyazamide, sold under the reference “SILQUEST® A-1387” by GE Silicones, with a solids content of 50%.

plasticizer:
ethoxylated fatty alcohols, sold under the reference “SETILON® KN” by Cognis, with a solids content of 57%
ethylene/vinyl acetate copolymer, sold under the reference “MOWILITH® 1871” by Vinamul, with a solids content of 53%;

viscosity control agent:
hydroxyethyl cellulose, sold under the reference “NATROSOL® 250 HBR” by Aqualon, with a solids content of 100%;

dispersants and lubricants:
alkylamidoamine, sold under the reference “SODAMINE® P 45” by Arkema, with a solids content of 100%;
mixture of polyether phosphates sold under the reference “TEGO DISPERSE 651” by Degussa, with a solids content of 30%;
mixture of ethoxylated alcohol and glycerol esters, sold under the reference “TEXLUBE® NI/CS2” by Achitex, with a solids content of 100%;
alkylamidoamine acetate, sold under the reference “CATIONIC SOFTENER FLAKES® ” by Goldschmidt, with a solids content of 100%;
modified polyethylene wax, sold under the reference “HYDROCER® 145” by Shamrock, with a solids content of 50%; and

antifoaming agent:
polyether, sold under the reference “TEGO FOAMEX® 830” by Degussa, with a solids content of 100%.

In these examples, the tensile strength of the strand was measured after a wet aging treatment in a chamber saturated with water vapor at 80° C.

### EXAMPLES 1 TO 7

These examples illustrate glass strands coated with coating compositions containing clay nanoparticles.

The coating compositions contain the raw materials given in Table 1 (in % by weight).

The compositions were prepared under the following conditions:

The polyvinyl alcohol (CELVOL® 325) was dispersed in water at room temperature (20-25° C.), with stirring, then the dispersion was heated to 80° C. until a solution was obtained.

The nanoparticles were dispersed in water containing the antifoaming agent (TEGO FOAMEX® 830) and the lubricant (HYDROCER® 145), then the dispersion was treated in an Ultraturax® (5 minutes at 9000 rpm/min).

The dispersion thus obtained was added to the first dispersion, then the plasticizer (MOWILITH® 1871) and the crosslinking agent (POLYCUP® 172LX) were introduced with vigorous stirring for at least 30 minutes. The viscosity of the dispersion was between 300 and 800 mPa·s to enable correct application onto the strand. If necessary, the viscosity may be adjusted by adding water to the dispersion.

The coating composition was applied onto a strand made from filaments of glass E of 13 μm diameter (300 tex), unwound from a package in the form of a cake, via immersion in a bath of said composition and passing through a calibration nozzle (volatile solids: 12 to 18%).

The strands used were coated with a base sizing composition that was free from nanoparticles (example 1) or contained nanoparticles (examples 2 to 7) in the amounts indicated below, expressed in % by weight:

Base sizing composition:

| | |
|---|---|
| EPIREZ ® 3510 W 60 | 4.00 |
| SILQUEST ® A-174 | 0.45 |
| SILQUEST ® A-1387 | 0.20 |
| NATROSOL ® 250 HBR | 0.20 |
| NEOXIL ® 962D | 2.50 |
| SETILON ® KN | 0.10 |
| TEXLUBE ® NICS2 | 0.30 |
| Water qsp 100% | |

Nanoparticles

| | Ex. 1 | | | | | | |
|---|---|---|---|---|---|---|---|
| | (comp.) | Ex. 2 | Ex. 3 | Ex. 4 | Ex. 5 | Ex. 6 | Ex. 7 |
| Clay | — | A | B | C | D | E | A |
| Content (%) | — | 0.24 | 0.24 | 0.24 | 0.24 | 0.24 | 0.72 |

The tensile strength of the glass strands coated with the coating composition tested under the wet aging conditions is given in table 1.

TABLE 1

| | Ex. 1 | | | | | | |
|---|---|---|---|---|---|---|---|
| | (comp.) | Ex. 2 | Ex. 3 | Ex. 4 | Ex. 5 | Ex. 6 | Ex. 7 |
| CELVOL ® 325 | 12.00 | 12.00 | 12.00 | 12.00 | 12.00 | 12.00 | 12.00 |
| POLYCUP ® 172LX | 1.85 | 1.85 | 1.85 | 1.85 | 1.85 | 1.85 | 1.85 |
| MOWILITH ® 1871 | 3.23 | 3.23 | 3.23 | 3.23 | 3.23 | 3.23 | 3.23 |
| HYDROCER ®145 | 0.30 | 0.30 | 0.30 | 0.30 | 0.30 | 0.30 | 0.30 |
| TEGO FOAMEX ®830 | 0.20 | 0.20 | 0.20 | 0.20 | 0.20 | 0.20 | 0.20 |
| Clay A | — | 0.74 | — | — | — | — | 2.22 |
| Clay B | — | — | 0.74 | — | — | — | — |
| Clay C | — | — | — | 0.74 | — | — | — |
| Clay D | — | — | — | — | 0.74 | — | — |
| Clay E | — | — | | | | 0.74 | — |
| Water qsp 100 | | | | | | | |
| Tensile strength (MPa) | | | | | | | |
| 0 days | 1540.04 | 1354.53 | 1389.42 | 1259.87 | 1249.66 | 1325.79 | 1338.02 |
| 3 days | 1448.46 | 1374.53 | 1247.75 | 1401.70 | 1329.04 | 1370.23 | 1229.14 |
| 14 days | 924.64 | 1309.63 | 1415.82 | 1314.74 | 1286.35 | 1347.38 | 1077.27 |
| Change (%) | — | +41.6 | +53.1 | +42.1 | +39.1 | +45.7 | +16.5 |

In relation to example 1 which does not contain any nanoparticles, the strands from examples 2 to 7 according to the invention have a better wet aging resistance characterized by a very high tensile strength after 3 days and 14 days.

The strands containing nanoparticles grafted with a silane have a particularly high aging resistance after 14 days with an improvement of 39.1% (example 5) to 53.2% (example 3) in relation to the strand that is free from nanoparticles.

The strand from example 7 containing a higher level of nanoparticles than the strand from example 2 has a worse aging resistance while having a better resistance than for the strand from example 1 without nanoparticles.

### EXAMPLES 8 TO 15

These examples illustrate the glass strands coated with coating compositions containing boehmite nanoparticles.

The coating compositions contain the raw materials given in Table 2 (in % by weight).

These compositions were prepared under the following conditions:

The boehmite nanoparticles were poured into a mixture of dispersant (TEGO DISPERS® 651) and antifoaming agent (TEGO FOAMEX® 830), then one part of the polymer (STYRONAL® 517), was added, and the mixture was treated in an Ultraturax® (30 minutes at 5000 rpm). Next, the other part of the polymer was added and it was again treated in the Ultraturax® (5 minutes at 5000 rpm). The viscosity of the dispersion was between 300 and 800 mPa·s to enable a correct application onto the strand. If necessary, the viscosity may be adjusted by adding water to the dispersion.

The coating composition was applied to a strand made from filaments of glass E of 13 μm diameter (300 tex), unwound from a package in the form of a cake, via immersion in a bath of said composition and passing through a calibration nozzle (volatile solids 30 to 40%).

The strands A and B were coated with the following sizing composition (in % by weight):

| | Strand A | Strand B |
|---|---|---|
| SODAMINE ® P 45 | 0.07 | 0.07 |
| Boehmite C | — | 0.34 |
| SILQUEST ® A-174NT | 0.21 | 0.21 |
| SILQUEST ® A-1387 | 0.28 | 0.28 |
| CATIONIC SOFTENER FLAKES ® | 0.11 | 0.11 |
| ETS4 | 5.04 | 5.04 |
| Water qsp 100 | | |

The tensile strength of the glass strands coated with the coating composition tested under the wet aging conditions is given in table 2.

The strands coated with a size containing nanoparticles (examples 12 to 15) have a better wet aging resistance than the strands in which the size does not contain nanoparticles (examples 8 to 11).

TABLE 2

| | Ex. 8 | Ex. 9 | Ex. 10 | Ex. 11 | Ex. 12 | Ex. 13 | Ex. 14 | Ex. 15 |
|---|---|---|---|---|---|---|---|---|
| Strand | A | A | A | A | B | B | B | B |
| STYRONAL ® 517 | 66.65 | 66.65 | 66.65 | 66.65 | 66.65 | 66.65 | 66.65 | 66.65 |
| TEGO DISPERS ® 651 | 1.65 | 1.65 | 1.65 | 1.65 | 1.65 | 1.65 | 1.65 | 1.65 |
| TEGO FOAMEX ®830 | 0.38 | 0.38 | 0.38 | 0.30 | 0.38 | 0.38 | 0.38 | 0.38 |
| Boehmite A | 13.57 | — | — | — | 13.57 | — | — | — |
| Boehmite B | — | 15.40 | — | — | — | 15.40 | — | — |
| Boehmite C | — | — | 3.80 | — | — | — | 3.80 | — |
| Boehmite D | — | — | — | 3.80 | — | — | — | 3.80 |
| Water qsp 100 | | | | | | | | |
| Tensile strength (MPa) | | | | | | | | |
| 0 days | 1601.2 | 1820.4 | 1645.4 | 1740.6 | 1762.8 | 1764.0 | 1484.6 | 1680.7 |
| 3 days | 1191.6 | 1734.7 | 1454.8 | 1540.2 | 1733.3 | 1843.95 | 1743.7 | 1766.3 |
| 14 days | 1506.1 | 1894.2 | 1737.8 | 1785.9 | 1944.5 | 2033.65 | 1922.0 | 2000.9 |
| 30 days | 1314.5 | 1655.0 | 1498.7 | 1502.5 | 1501.9 | 1601.9 | 1538.6 | 1605.8 |
| 60 days | 1120.6 | 1380.5 | 1230.2 | 1265.7 | 1336.8 | 1541.4 | 1467.6 | 1613.7 |

1. A reinforcing glass strand or a reinforcing glass strand structure equipped with a coating composition, obtained from a solution and/or a suspension and/or an emulsion that comprises (in % by weight of solids):
60 to 95% of at least one polymer;
2 to 18% of nanoparticles.

2. The glass strand or glass strand structure as claimed in claim 1, characterized in that the polymer is a polyvinyl alcohol, a polyvinyl acetate, a polyvinyl chloride, a styrene-butadiene (SBR) or nitrile-butadiene (NBR) polymer or an acrylic polymer.

3. The glass strand or glass strand structure as claimed in claim 1, characterized in that the nanoparticles are composed of more than 30% by weight of a mineral material, preferably more than 40%.

4. The glass strand or glass strand structure as claimed in claim 3, characterized in that the nanoparticles are based on clay or boehmite.

5. The glass strand or glass strand structure as claimed in claim 1, characterized in that the nanoparticles are treated by an agent that helps to slow down the diffusion of water, preferably a hydrophobic agent.

6. The glass strand or glass strand structure as claimed in claim 5, characterized in that the agent is a compound of formula RₐXY₄₋ₐ in which:
R represents a hydrogen atom or a hydrocarbon-based radical incorporating 1 to 40 carbon atoms, said radical possibly being linear, branched or cyclic, saturated or unsaturated, possibly containing one or more O or N hetero atoms or being substituted by one or more amino, carboxylic acid, epoxy or amido groups, and the R groups being identical or different;
X represents Si, Zr or Ti;
Y is a hydrolysable group containing 1 to 12 carbon atoms, optionally containing one or more O or N hetero atoms, or a halogen, preferably Cl; and
a is equal to 1, 2 or 3.

7. The glass strand or glass strand structure as claimed in claim 6, characterized in that the compound is an organosilane, incorporating two or three alkoxy groups.

8. The glass strand or glass strand structure as claimed in claim 1, characterized in that the polymer represents 75 to 90% by weight of the coating composition.

9. The glass strand or glass strand structure as claimed in claim 1, characterized in that the nanoparticles represent 2.5 to 15% by weight of the coating composition.

10. The glass strand or glass strand structure as claimed in claim 1, characterized in that the coating composition represents 8 to 200% of the weight of the final strand or of the final strand structure.

11. A coating composition for the glass strand or glass strand structure, characterized in that it comprises:
8 to 90% of at least one polymer, preferably 10 to 75%;
1 to 15% of nanoparticles, preferably 1.5 to 10%;
0 to 10% of at least one lubricant, preferably 0.1 to 6%;
0 to 15% of at least one dispersant, preferably 0.1 to 8%; and
0 to 15% of at least one viscosity control agent, preferably 0.1 to 8%.

12. The coating composition as claimed in claim 11, characterized in that it has a solids content that varies from 8 to 90%, preferably 15 to 75%.

13. A method for preparing a coating composition as claimed in claim 11 that comprises the following steps:
a) the nanoparticles are dispersed in the solvent, preferably in the presence of a dispersant and if necessary a viscosity control agent; and
b) the polymer and the optional constituents are added to the nanoparticle dispersion.

14. The method as claimed in claim 13, characterized in that the dispersion from step a) is carried out under high shear conditions, for example in an Ultraturax® device and/or an ultrasound device.

15. A composite comprising at least one organic and/or inorganic material and reinforcing glass strands or one or more reinforcing glass strand structures, characterized in that said strands or structure(s) are completely or partly made from glass strands or structure(s) equipped with a coating as claimed in claim 1.

16. The composite as claimed in claim 14, characterized in that it contains 0.5 to 75% by weight of glass, preferably 5 to 50%.
